(19) United States
(12) Patent Application Publication
(10) Pub. No.: US 2010/0235638 A1
(43) Pub. Date: Sep. 16, 2010

(54) IDENTIFICATION AND AUTHENTICATION OF DEVICES IN A NETWORK

(75) Inventor: James Irvine, Glasgow (GB)

Correspondence Address: PEPPER HAMILTON LLP, ONE MELLON CENTER, 50TH FLOOR, 500 GRANT STREET, PITTSBURGH, PA, 15219, US

(73) Assignee: ITI SCOTLAND LIMITED, Glascow (GB)

(21) Appl. No.: 12/670,381

(22) PCT Filed: Jul. 30, 2008
(86) PCT No.: PCT/GB08/02598

§ 371 Date: Apr. 21, 2010

(30) Foreign Application Priority Data
Aug. 1, 2007 (GB) 0715023.8

(51) Int. Cl. H04L 9/08; H04L 9/32

(52) U.S. Cl. 713/168; 380/278

(57) ABSTRACT

A method of distributing a network access key to devices in a network comprises the steps of generating a network access key, and generating a plurality of distinct key shares for the network access key. A device requires a predetermined number of distinct key shares to generate the network access key. Key shares are distributed to devices in the network, such that at least one device receives a plurality of distinct key shares.

### TECHNICAL FIELD OF THE INVENTION

The invention relates to the identification and authentication of devices in a network, and in particular relates to the identification and authentication of devices in personal area networks based on threshold cryptographic schemes.

### BACKGROUND TO THE INVENTION

Wireless consumer electronics devices are becoming more ubiquitous, and it is becoming increasingly important to ensure that communications between devices forming a network are secure and that unauthorised or undesirable devices are unable to access the network or eavesdrop on communications. Such devices include relatively complex devices, like set-top boxes, personal digital assistants (PDAs), laptops, phones, cameras, etc., and also much more simple devices such as key fobs, remote controls, etc.

The security requirements of devices are often not directly related to their complexity, but their complexity can affect the type or nature of the security protocol that can be implemented in the network. A compromised remote control would only be a nuisance, whereas a compromised key fob could allow an intruder access to the home or car.

Users of such devices want a simple way of connecting or associating all their devices with one another so that they can interact securely, but without leaving security holes that could be exploited by other devices that are not part of the network. However, many users do not want to have to think about security or its management. In addition, the diversity of devices is such that there are many very simple devices with low computing power and limited user interfaces (for example a single button in the case of a key fob or wireless headset), which puts constraints on possible security approaches.

Significant problems for establishing security in a wireless network include identification of the devices in the network and authentication of their identity and associated access level. A successful resolution of these problems will allow a new device to be easily associated with the user's network, whilst ensuring that the network is secure against impostor devices.

Four known protocols for achieving these aims are set out below.

The first protocol uses simple bindings, in which two devices are directly associated or paired with each other (for example as in Bluetooth). One problem with this approach is that as the number of devices in the network increases, the number of pairings rises exponentially, and if a single device is compromised (for example by being lost or stolen), it is difficult to revoke its access rights to the network without reconfiguring all of the other devices in the network.

A second protocol uses certificates associated with a unique ID (for example as in network cards). This approach requires a personal certification authority which is guaranteed by a higher certification authority using an infrastructure such as a Public Key Infrastructure (PKI). However, using public key certificates is computationally intensive (which can significantly affect the battery life of portable devices) and requires a complex management infrastructure. It is again difficult to revoke access rights if a device becomes compromised.

A third type of protocol uses a security manager application that runs on one of the devices, and has a gatekeeper ‘vault’ containing all of the security details for all of the devices in the network. New devices are associated with the security manager (and the appropriate security details stored), and individual devices within the network can contact the security manager to check the relevant credentials are in place when required. The difficulty with this approach is that contact with the security manager must be maintained for the network to operate securely, and the network is vulnerable to loss or compromise of the security manager.

The fourth approach uses threshold techniques (otherwise known as secret sharing), in which devices operate in a co-operative manner to ensure security. The basics of threshold schemes were proposed by Adi Shamir, of Massachusetts Institute of Technology, in the paper, “How to share a secret”, published in the Communications of the ACM, vol 22, pp 612-3, November 1979. A number of practical threshold cryptographic schemes have subsequently been published (see, for example, Yvo Desmedt, “Some recent research aspects in threshold cryptography”, ISW97). A network access scheme was proposed for wide area networks with multiple access points in “A secure network access protocol (SNAP)”, ISCC2003, June 2003 by Al Shahri, Smith and Irvine. Methods for providing multiple shares from a common secret, for example for use in digital rights management schemes, have been described in U.S. Pat. No. 5,903,649 to Schwenk.

However, traditional threshold techniques are relatively inflexible for access control, and require a large number of co-operating devices.

Current systems mainly use simple binding, although, as described above, this becomes impractical as the number of devices increases.

There is therefore a need for a protocol that allows devices to be identified and authenticated in a network.

### SUMMARY OF THE INVENTION

According to a first aspect of the invention, there is provided a method of distributing a network access key to devices in a network, the method comprising generating a network access key; generating a plurality of distinct key shares for the network access key, wherein a device requires a predetermined number of distinct key shares to generate the network access key; and distributing the key shares to devices in the network, such that at least one device receives a plurality of distinct key shares.

According to a second aspect of the invention, there is provided a method of operating a device to access a network of devices; the devices in the network using a network access key, the devices in the network having a respective key share or key shares, wherein a predetermined number of distinct key shares are required to generate the network access key; the method comprising sending a key share request to another device in the network; receiving the respective key share or key shares from the device in the network; if the device has the predetermined number of distinct key shares, generating the network access key from the key shares; and using the generated network access key to access the network.

According to a third aspect of the invention, there is provided a security manager component comprising means for generating a network access key; means for generating a plurality of distinct key shares for the network access key, wherein a device requires a predetermined number of distinct key shares to generate the network access key; and means for distributing the key shares to devices in the network, such that at least one device receives a plurality of distinct key shares. According to a fourth aspect of the invention, there is provided a communications device for use in a communications network comprising a plurality of devices, the devices in the network using a network access key to access the communications network, the devices in the network having a respective key share or key shares, wherein a predetermined number of distinct key shares are required to generate the network access key; the communications device comprising means for sending a key share request to another device in the network; means for receiving the respective key share or key shares from the device in the network; means for generating the network access key from the key shares if the device has the predetermined number of distinct key shares, and means for using the generated network access key to access the network.

### BRIEF DESCRIPTION OF THE DRAWINGS

The invention will now be described, by way of example only, with reference to the following drawings, in which:

FIG. 1 shows a wireless personal area network in accordance with the invention;

FIGS. 2(a) and (b) illustrate a method in accordance with the invention; and

FIG. 3 is a flow chart illustrating a further method in accordance with the invention.

### DETAILED DESCRIPTION OF THE PREFERRED EMBODIMENTS

The invention will now be described with reference to the identification and authentication of devices for use in a personal wireless area network that uses ultra wideband in accordance with the ECMA-368 specification. However, it will be appreciated that the invention can be readily applied to devices for use in many other types of network.

Essentially, the invention is a combination or hybrid of the security manager application and threshold technique described above.

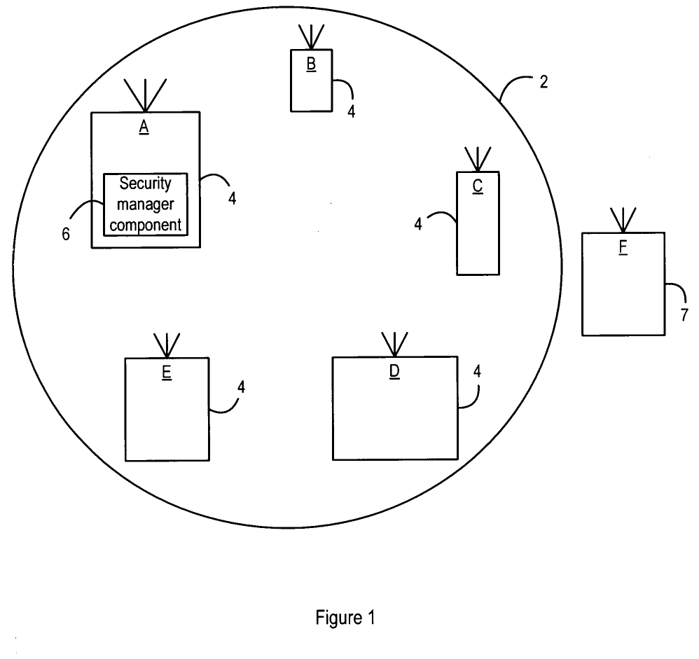

FIG. 1 shows a wireless personal area network 2 in accordance with the invention. The wireless personal area network 2 includes a plurality of devices 4 (labelled device A, device B, device C, device D and device E respectively), each with a respective antenna for transmitting and receiving data from other devices 4. Each device 4 can be any type of device that can be found in a personal area network, including, but not limited to, a home computer, a laptop, a television, a mobile phone, a personal digital assistant, a printer, a remote control or a key fob. Thus, any of the devices 4 could be a device with a low level of complexity and functionality or a device with a high level of complexity and functionality.

In the personal area network 2, at least one device 4 comprises or runs a security manager component 6, which may be implemented in hardware and/or software. In this illustrated embodiment, device A is running the security manager component 6. Device A, for example, may be a relatively complex device, such as a home computer or a laptop. Alternatively, device A may be a bulky device that cannot be moved easily, or a device that is physically secured to a particular location, i.e. devices that are not necessarily complex, but nevertheless secure in view of their physical attributes. Device A may also be a dedicated control device that has been devised specifically for the purpose of running the security manager component 6.

The security manager component 6 is responsible for generating and distributing (using threshold techniques) a network access key, which is to be used by each device 4 to gain and maintain access the network 2.

A further device is shown in FIG. 1. This device 7 (labelled device F) is not yet part of the personal area network 2, but would like to join.

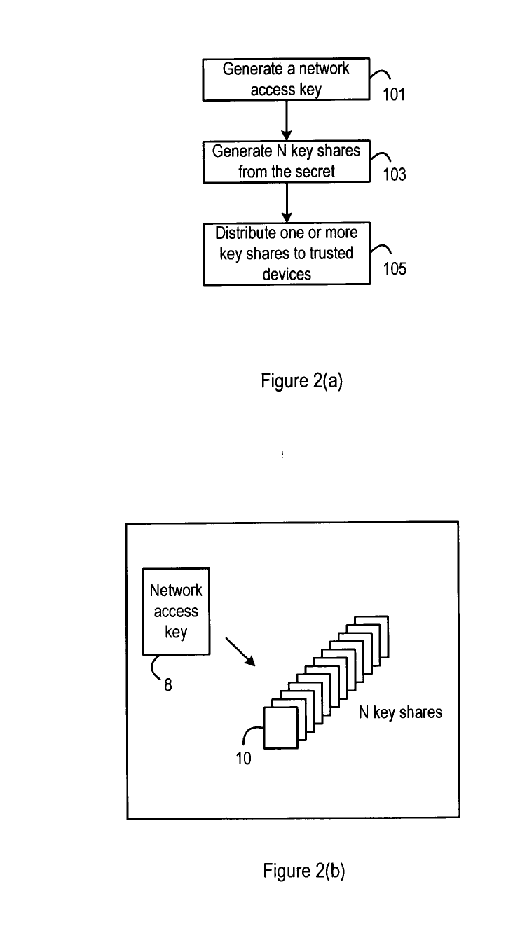

Part of the operation of the security manager component 6 in setting up a security protocol is shown in FIG. 2. In step 101 of FIG. 2(a), the security manager component 6 generates a network access key 8. In step 103, the security manager component 6 generates a plurality of key shares 10 for the network access key 8.

The network access key 8 and plurality of key shares 10 are generated using a threshold technique. This means that the network access key 8 can be regenerated by a device from a defined number of distinct key shares 10, but no information about the network access key 8 can be determined by a device if it has less than the defined number of key shares 10. Any suitable threshold technique can be used.

In the following example, the total number of distinct key shares 10 generated for the network access key 8 is N, where N is an integer, and the number of distinct key shares 10 a device requires in order to regenerate the network access key 8 is k, where k is an integer and 0≦k≦N. Thus, no information about the network access key 8 can be derived by a device if it has k−1, or less, key shares 10.

Once the key shares 10 have been generated, the key shares 10 are distributed to devices 4 that are trusted by the security manager component 6 (step 105). In the following, the devices 4 in the personal area network 2 are devices that are considered to be trusted devices (i.e. their identity has been verified). The devices 4 store the key share or shares 10 in a memory (not shown). In accordance with an aspect of the invention, a trusted device 4 may be provided with more than one distinct key share 10.

According to one embodiment, the number of key shares 10 that a trusted device 4 is provided with depends on the level of trust afforded to that device 4. For example, the level of trust may be based on the complexity and/or functionality of the device 4. Alternatively, the level of trust may be based on some other attribute, for example a SIM card may be allocated a high level of trust, despite having a relatively low complexity.

It should be noted that the method shown in FIG. 2(a) can take place when a security manager component 6 is first activated (perhaps when a network 2 is initially being set up), or when the network access key 8 needs to be changed (which may occur periodically, for example after the loss or compromise of a device in the network 2, or after a breach of the integrity of the network by a third party device). The network access key 8 may be changed when a device is lost or removed from the network. It is also noted that the periodic changing of the network access key 8 may be made at other predetermined periods, regardless of any other event occurring.

The security manager component 6 can also provide a key share or shares 10 to device F, if it considers the device 7 to be a trusted device. The device 7 can be trusted by the security manager component 6, even though it is not yet part of the personal area network 2. In one embodiment, the security manager component 6 can provide the device 7 with k−1 distinct key shares 10.

The way in which devices are determined to be trusted can be set according to the type of device or network, or according to the preference of a user or administrator of the network. Any suitable authentication method may be used. For example, in the case of a simple device, a signal sent from the device in response to a key press by the user could be sufficient to earn “trusted” status, provided that the security manager component 6 was expecting such a signal. Alternatively, for more complex devices, a password or biometric identifier could be entered into the device and transmitted to the device 4 running the security manager component 6 for comparison with corresponding information stored therein. If the information matches, or is within acceptable limits, the device 7 can be designated a trusted device.

In one embodiment, once a device has been designated a trusted device, the security manager component 6 adds the identity of the device to a ‘safe’ list, which is then provided to all of the trusted devices. The safe list includes the identities of all of the trusted devices (including the device 4 on which the security manager component 6 is running), and allows the trusted devices to recognise each other, without having to carrying out extensive identification or authentication procedures themselves. In this way, the identification and authentication of new devices 7 can be left to the security manager component 6 which is likely to be executing on a relatively complex device 4. Thus, the computational requirements of the inventive protocol is minimised for the other devices 4 in the network 2.

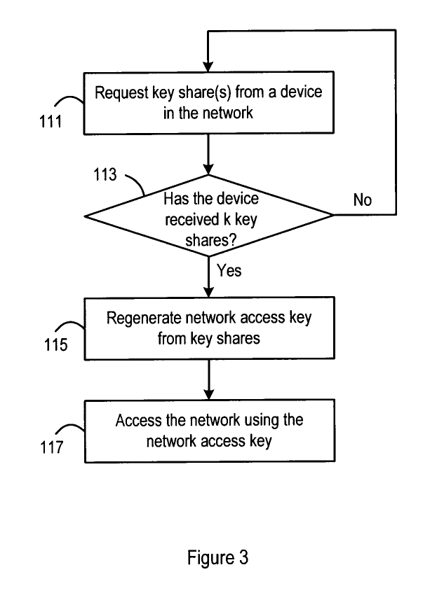

FIG. 3 illustrates a method of operating a device after receiving a key share or shares 10 from the security manager component 6. In step 111, the device (which could be any of devices A-E after it has received a key share or shares 10 following a change in the network access key 8 by the security manager component 6, or device F after receiving a key share or shares 10 after establishing that it is a trusted device) requests that another device transmits its stored key share or shares 10 to the device.

In step 113, the device determines whether it has k or more distinct key shares 10 available. The key shares 10 can be a combination of key shares 10 received from the security manager component 6 and one or more trusted devices 4, or key shares 10 received solely from the trusted devices 4.

If the device does not have k distinct key shares 10, the method returns to step 111, where it sends a request for key shares 10 to another device 4. If the device does have k or more distinct key shares 10, the method passes to step 115 in which the device generates the network access key 8 from the key shares 10. This regeneration is carried out in the manner appropriate for the threshold technique used to generate the key shares 10 in the first place.

Once the device has generated the network access key 8, the device can access the network 2 using the key 8 (step 117).

It should also be noted that, in some embodiments, a device does not necessarily have to be trusted by the security manager component 6 in order to join the network. In fact, it is not necessary for a device to receive a key share 10 from the security manager component before performing the method shown in FIG. 3. However, in this case, the device 7 will need to establish trust with at least one of the other devices 4 in the network 2 in order for that device 4 to transmit its key share or shares 10 to the device 7. This trust could be established by, for example, the device transmitting the request in step 111, and a “send” button being pressed on the recipient of the request. Alternatively, the trust establishment can be carried out as described above for the security manager component 6. In some embodiments, it may be necessary for the device 7 to establish trust with each of the devices 4 that it requests key shares 10 from.

Thus, in accordance with the preferred embodiment in which the number of key shares 10 stored in a device 4 depends on the complexity and/or functionality of the device 4, it is not necessary for a new device 7 to contact k devices (and carry out k authentication procedures as a result) in order to collect enough key shares 10 to regenerate the network access key 8. Devices 4 that are more complex and/or have a higher functionality are capable of implementing tougher identification and authentication procedures (for example including passwords and biometric information), and can be entrusted with more key shares 10 than devices that are simpler and/or have lower functionality. The number of key shares 10 that a device 4 has can also depend on how likely it is that the device could be lost or compromised.

Thus, in the embodiment in which the security manager component 6 provides the device 7 with k−1 distinct key shares 10, it is only necessary for the device 7 to receive key shares 10 from one other device 4.

Thus, the different number of shares being distributed to different devices allows a trade off between centralised and distributed access. Devices that are more complex or have increased functionality (processing and/or user interface) would be able to distribute more shares as more complex (and more secure) bindings or pairings between such devices could be obtained. A device is only able to pass on as many shares as it itself has access to, meaning that if it is compromised or lost, it could not be used by a third party to allow a greater compromise of network security.

In addition, in a further embodiment of the invention, the security manager component 6 can determine network access keys 8 that provide different levels of access to the network 2. Preferably, keys 8 that provide a higher level of access to the network 2 require an increased number of key shares 10 in order to be generated. Thus, very limited access to the network 2 could be allowed to a device having only a single share; for example, peer-to-peer communication. This would allow a user to purchase a device, e.g. a wireless headset, and to use it with one of their existing devices without having to bind or pair it with the security manager component, which is a major advantage of the distributed approach.

As described above, the network access key 8 could be periodically regenerated, and the resulting key shares 10 sent to connected devices 4 in the personal area network 2. Devices which are registered but unconnected (i.e. they are known to the security manager application 6, but are not currently connected to the network 2), can have key shares 10 passed to them when they reconnect.

If a device 4 is compromised or lost, or intentionally removed from the network, it can be deregistered, and a new network access key 8 generated. New key shares 10 can be distributed in the normal fashion, but as the compromised device has been deregistered, it would have to rebind with other devices 4 if it was reintroduced into the network. As long as the deregistered device cannot obtain k distinct key shares from unconnected devices not aware of its deregistered status, it will not be able to access the network. This is why a security manager component 6 should not be able to distribute all k required key shares 10 to a new device 7.

There is a trade off between the number of devices (connected or unconnected) in a network 2, the number of key shares 10 required to form the network access key 8, the difficulty of binding or pairing a new device to the network 2 and the difficulty of revoking the credentials of compromised devices. In general, the more key shares 10 required for a given network size, the harder it is to bind or pair devices 4, but the easier it is to revoke the credentials of devices.

There is therefore provided a method of identifying and authenticating devices into a network, while maintaining the integrity of the network in the event that a device is compromised.

1. A method of distributing a network access key to devices in a network, the method comprising:
generating a network access key;
generating a plurality of distinct key shares for the network access key, wherein a device requires a predetermined number of distinct key shares to generate the network access key; and
distributing the key shares to devices in the network, such that at least one device receives a plurality of distinct key shares.

2. The method as claimed in claim 1, wherein the number of key shares distributed to a device depends on a trust value assigned to that device.

3. The method a claimed in claim 2, wherein the trust value of a device is determined according to the physical attributes, complexity and/or functionality of that device.

4. The method as claimed in claim 1, wherein the plurality of distinct key shares is an integer N, and wherein the predetermined number of distinct key shares is k, and wherein 0≦k≦N.

5. The method as claimed in claim 4, wherein no device has more than a predetermined number of shares (k)−1.

6. The method as claimed in claim 1, wherein the predetermined number of distinct key shares provides a predetermined level of access to the network.

7. The method as claimed in claim 6, wherein a device requires a second number of distinct key shares to obtain a different level of access to the network.

8. The method as claimed in claim 1, further comprising the step of periodically regenerating the network access key, generating the plurality of distinct key shares for the regenerated network access key, and distributing the key shares to devices in the network.

9. A method of operating a device to access a network of devices; the devices in the network using a network access key, the devices in the network having a respective key share or key shares, wherein a predetermined number of distinct key shares are required to generate the network access key; the method comprising:
sending a key share request to another device in the network;
receiving the respective key share or key shares from the device in the network;
if the device has the predetermined number of distinct key shares, generating the network access key from the key shares; and
using the generated network access key to access the network.

10. The method as claimed in claim 9, wherein, if the device has less than the predetermined number of distinct key shares, repeating the steps of sending and receiving until the device has the predetermined number of distinct key shares.

11. A security manager component comprising:
means for generating a network access key;
means for generating a plurality of distinct key shares for the network access key, wherein a device requires a predetermined number of distinct key shares to generate the network access key; and
means for distributing the key shares to devices in the network, such that at least one device receives a plurality of distinct key shares.

12. The security manager component as claimed in claim 11, wherein the means for distributing the key shares to devices in the network comprises means for determining a trust value assigned to a particular device, and means for distributing a corresponding number of shares to that device.

13. The security manager component as claimed in claim 12, wherein the trust value of a device is determined according to a physical attribute, complexity and/or functionality of that device.

14. The security manager component as claimed in claim 11, wherein the plurality of distinct key shares is an integer N, and wherein the predetermined number of distinct key shares is k, and wherein 0 N.

15. The security manager component as claimed in claim 14, wherein no device has more than a predetermined number of shares (k)−1.

16. The security manager component as claimed in claim 11, wherein the predetermined number of distinct key shares provides a predetermined level of access to the network.

17. The security manager component as claimed in claim 16, wherein a device requires a second number of distinct key shares to obtain a different level of access to the network.

18. The security manager component as claimed in claim 11, further comprising means for periodically regenerating the network access key, generating the plurality of distinct key shares for the regenerated network access key, and distributing the key shares to devices in the network.

19. A communications device for use in a communications network comprising a plurality of devices, the devices in the network using a network access key to access the communications network, the devices in the network having a respective key share or key shares, wherein a predetermined number of distinct key shares are required to generate the network access key; the communications device comprising:
means for sending a key share request to another device in the network;
means for receiving the respective key share or key shares from the device in the network;
means for generating the network access key from the key shares if the device has the predetermined number of distinct key shares, and
means for using the generated network access key to access the network.

20. The communications device as claimed in claim 19, further comprising means for determining if the device has less than the predetermined number of distinct key shares and, if so, sending a key request share and receiving a respective key share until the device has the predetermined number of distinct key shares.
